(19) United States
(12) Patent Application Publication
(10) Pub. No.: US 2018/0104977 A1
(43) Pub. Date: Apr. 19, 2018

(54) WRITING INSTRUMENT HOLDER

(71) Applicant: CONNIE M. CAMPBELL, HENDERSONVILLE, NV (US)

(72) Inventor: CONNIE M. CAMPBELL, HENDERSONVILLE, NV (US)

(21) Appl. No.: 15/298,042

(22) Filed: Oct. 19, 2016

(51) Int. Cl. B43K 29/02

(52) U.S. Cl. CPC B43K 29/02

(57) ABSTRACT

This invention relates to an accessory for crayon in the form of a cartoon character. The removable accessory for crayon is made of lightweight plastic and attached to bottom of the crayon. The accessory has an ‘ESS’ shape. The crayon topper is available in different colors.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

### (1) Field of the Invention

The present invention generally relates to the field of coloring crayons sticks. The invention, particularly relates to an article of manufacture installed over and around a coloring crayon sticks and related items.

### (2) Background of the Invention

Parents of young children nowadays prefer to buy toys or games that aid learning of their kids. It's a known fact that young children have capability to learn things quickly, thus it becomes a necessity for parents to develop their young minds as much as possible. One of the activities that involve developing of young minds is use of color. The children are provided with black and white images with thin border lines. The children can fill the space between the border lines with colors of their choice using the color sticks usually made of some form of colored wax Other color creating devices are known to be used for similar purposes, such as crayons, sketch pens, dry and wet colors or the like are all provided to children for their coloring exercise. These coloring means or devices come with accessories such as toys placed on bottom which the kids hold.

A number of different types of accessories for coloring means are available in prior art. For example, the following patents are provided for their supportive teachings and are all incorporated by reference: U.S. patent application Ser. No. 14/219,334 to Shelly; U.S. Pat. No. 5,597,593 to Lebensfeld et al.; U.S. Pat. No. 7,563,047 to Andrew; U.S. Pat. No. 6,435,749 to Giovanni; U.S. Pat. No. 6,116,982 to Roman et al.

Prior art U.S. patent application Ser. No. 14/219,334 discloses an implement supported doll is configured to include at least a head and upper torso of a conventional doll which is supported by a pen, pencil or stylus inserted into a receiving interior passage and attachment. Another Prior art U.S. Pat. No. 5,597,593 discloses toy mold systems usable by a child to form highly detailed, rigid molded toy figures. The systems include at least three preformed mold sections each having a configuration such that, in an assembled condition of the toy mold system, they define a mold cavity having at least one undercut.

Yet another Prior art U.S. Pat. No. 6,116,982 discloses an article of manufacture, which can be in various shapes and forms, based on the principle of magnetic levitation. When motion is applied to the article of manufacture, there results a body moving through the air without mechanical support. This invention can be used for many purposes including entertainment and educational uses.

There remains a constant need in society for a continuous flow of new and innovative novelty devices. Also, there is a constant need for new educational tools which help to bridge the gap between the known and unknown in a way that is understandable to different age groups. This need arises from a changing and mixing of various people and cultures having different and varied tastes when it comes to being entertained. It is in this context, that the subject invention is useful, not only to entertain and amuse, but also, in certain situations, to educate.

### SUMMARY OF THE INVENTION

In the view of the foregoing disadvantages inherent in the known types of accessories of coloring devices now present in the prior art, the present invention provides an improved accessory for crayons. As such, the general purpose of the present invention, which will be described subsequently in greater detail, is to provide a new and improved accessory for crayons which has all the advantages of the prior art and none of the disadvantages. An object of the invention is to provide an accessory for crayon in the form of a cartoon character.

It is another object of the present invention to provide a removable accessory for crayon made of lightweight plastic and attached to bottom of a crayon.

It is another object of the present invention to provide an accessory having an ‘ESS’ shape.

It is another object of the present invention to provide a crayon topper with different colors.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 depicts different views of the crayon topper.

FIG. 2 depicts perspective view of the crayon topper.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

The accessories for amusement of children that are associated with tools used by them are discussed in the present invention. The accessories for amusement can be anything that attracts or encourages young children to perform an educational activity using the tools associated with it. For example, to encourage creativity the children are provided with coloring means such as sketch pens, crayons, dry and wet colors or the like, together with a sketch book or drawing book. The children can add colors to the black and white sketches made available on pages of the sketch book using one of the above specified coloring means.

It is observed that children have a tendency to lose interest in a specific game or activity, when repeated on regular bases. Hence, to keep the children interest growing various methods can be employed. One of the methods employed is discussed in the present invention. According to preferred embodiment of the invention, the children are provided with crayons with toy figures attached to the bottom part. The toy figure of the present invention is ‘ESS’ shaped and made of lightweight plastic. The size of the crayon topper is large enough so it can't be swallowed. The crayon topper is a solid piece with a hole at the bottom, where the crayon is fitted. The crayon topper is also washable.

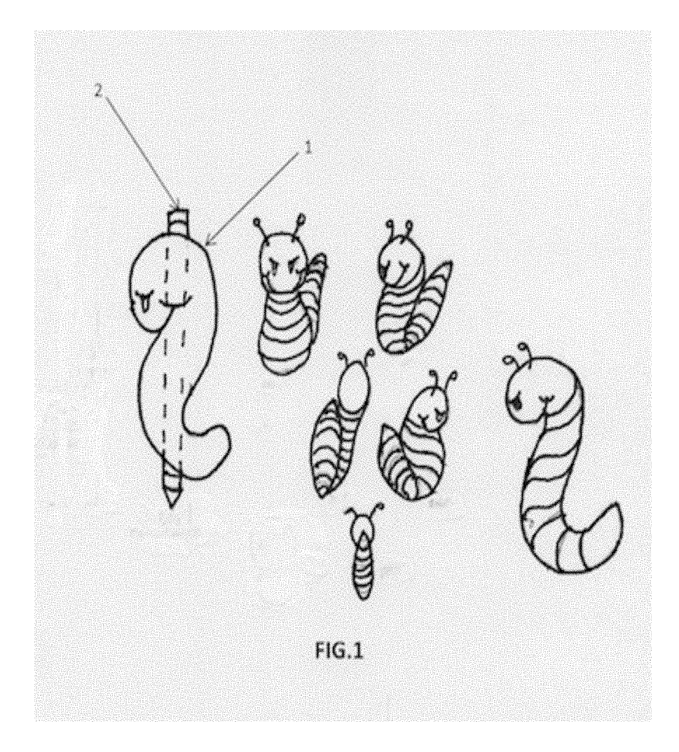

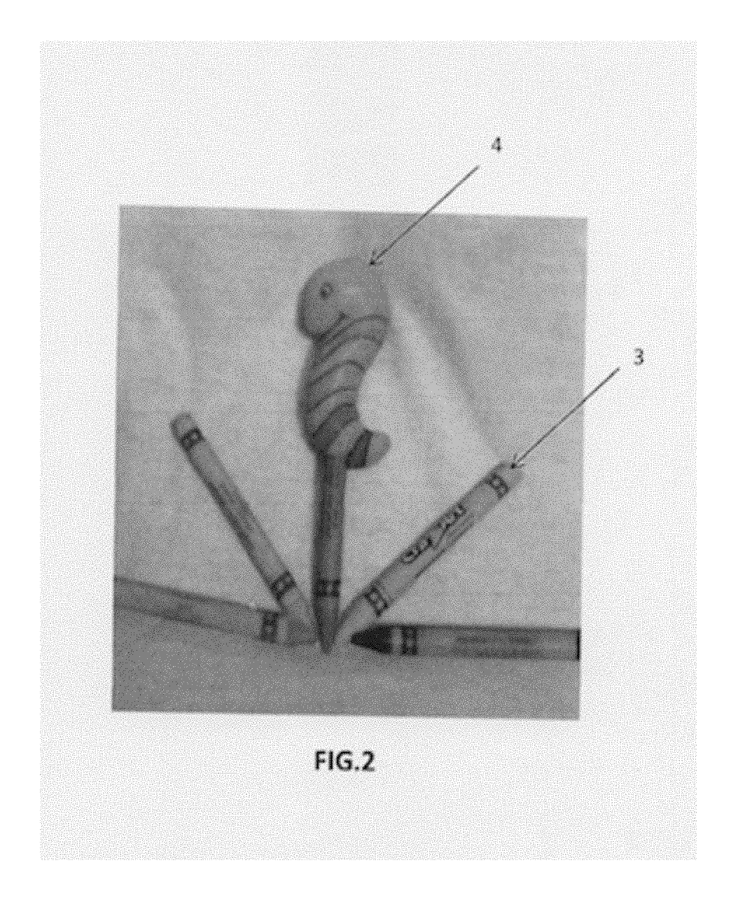

Referring to FIG. 1 shows different views of a crayon topper 1 and a crayon 2 fitted into the crayon topper. Similarly, referring to FIG. 2 shows a number of crayons and a crayon 3 fitted with a crayon topper 4.

In particular, although the presently illustrated invention depicts a worm type figure, one skilled in the art will easily understand that any type of figurine or toy may be sufficient to satisfy the teachings of the present invention intent. Additionally, it is intended to include a coloring book (not illustrated), filled with images that match the characters that are placed over the coloring stick, or crayon. Thus, allowing a child to have physical interaction with the images found in the book that are intended to be colored by the user.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

1-9. (canceled)

10. (canceled)

11. An accessory mounted on a crayon, consisting essentially of:
a) a body, in a shape of an S-shaped worm, with a width wider than the crayon, consisting essentially of:
i) at least one cavity longitudinally formed therethrough with at least one opening communicating with an exterior of the body;
ii) a top portion of the S-shaped worm forms a head with eyes;
iii) a body portion of the S-shaped worm forms a body that extends from one side of a crayon and then to another side of the crayon;
iv) a bottom portion of the S-shaped worm forms a tail that extends generally way from the crayon and opposite to the top portion of the S-shaped worm;
b) wherein a longitudinal portion of the crayon is enveloped by the cavity, preventing a users hand from contacting a substantial portion of the crayon;
c) wherein the body is removably mounted on the crayon; and
d) wherein the body is made of a colored pliable material.
